(19) United States
(12) Patent Application Publication
(10) Pub. No.: US 2006/0258248 A1
(43) Pub. Date: Nov. 16, 2006

(54) Fiberglass binder comprising epoxidized oil and multifunctional carboxylic acids or anhydrides

(76) Inventors: Kiarash Alavi Shooshtari, Littleton, CO (US); Diana Kim Fisher, Littleton, CO (US)

Correspondence Address: JOHNS MANVILLE, 10100 WEST UTE AVENUE, LITTLETON, CO, 80127, US

(21) Appl. No.: 11/126,584

(22) Filed: May 11, 2005

(51) Int. Cl. B32B 5/02; D04H 13/00; D04H 1/00

(52) U.S. Cl. 442/327; 442/417; 442/59

(57) ABSTRACT

Provided is a fiberglass binder composition which comprises epoxidized oil and a multifunctional carboxylic acid or anhydride. The resultant binder provides minimal processing difficulties and a fiberglass product which exhibits minimal water absorption.

### FIELD OF THE INVENTION

The subject invention pertains to cross-linked epoxidized oils and multifunctional carboxylic acids or anhydrides polymer binding resins having improved water repellancy properties. More particularly, the subject invention pertains to epoxidized oil based binder resins which cure by crosslinking with multifunctional carboxylic acids or anhydrides. Such binders are useful as replacements for formaldehyde-based binders in non-woven fiberglass goods.

### BACKGROUND OF THE INVENTION

Fiberglass binders have a variety of uses ranging from stiffening applications where the binder is applied to woven or non-woven fiberglass sheet goods and cured, producing a stiffer product; thermo-forming applications wherein the binder resin is applied to a sheet or lofty fibrous product, following which it is dried and optionally B-staged to form an intermediate but yet curable product; and to fully cured systems such as building insulation.

Fibrous glass insulation products generally comprise matted glass fibers bonded together by a cured thermoset polymeric material. Molten streams of glass are drawn into fibers of random lengths and blown into a forming chamber where they are randomly deposited as a mat onto a traveling conveyor. The fibers, while in transit in the forming chamber and while still hot from the drawing operation, are sprayed with an aqueous binder. A phenol-formaldehyde binder has been used throughout the fibrous glass insulation industry. The residual heat from the glass fibers and the flow of air through the fibrous mat during the forming operation are generally sufficient to volatilize the majority to all of the water from the binder, thereby leaving the remaining components of the binder on the fibers as a viscous or semi-viscous high solids liquid. The coated fibrous mat is transferred to a curing oven where heated air, for example, is blown through the mat to cure the binder and rigidly bond the glass fibers together.

Fiberglass binders used in the present sense should not be confused with matrix resins which are an entirely different and non-analogous field of art. While sometimes termed “binders”, matrix resins act to fill the entire interstitial space between fibers, resulting in a dense, fiber reinforced product where the matrix must translate the fiber strength properties to the composite, whereas “binder resins” as used herein are not space-filling, but rather coat only the fibers, and particularly the junctions of fibers. Fiberglass binders also cannot be equated with paper or wood product “binders” where the adhesive properties are tailored to the chemical nature of the cellulosic substrates. Many such resins are not suitable for use as fiberglass binders. One skilled in the art of fiberglass binders would not look to cellulosic binders to solve any of the known problems associated with fiberglass binders.

Binders useful in fiberglass insulation products generally require a low viscosity in the uncured state, yet characteristics so as to form a rigid thermoset polymeric mat for the glass fibers when cured. A low binder viscosity in the uncured state is required to allow the mat to be sized correctly. Also, viscous binders tend to be tacky or sticky and hence they lead to accumulation of fiber on the forming chamber walls. This accumulated fiber may later fall onto the mat causing dense areas and product problems. A binder which forms a rigid matrix when cured is required so that a finished fiberglass thermal insulation product, when compressed for packaging and shipping, will recover to its as-made vertical dimension when installed in a building.

From among the many thermosetting polymers, numerous candidates for suitable thermosetting fiberglass binder resins exist. However, binder-coated fiberglass products are often of the commodity type, and thus cost becomes a driving factor, generally ruling out such resins as thermosetting polyurethanes, epoxies, and others. Due to their excellent cost/performance ratio, the resins of choice in the past have been phenol/formaldehyde resins. Phenol/formaldehyde resins can be economically produced, and can be extended with urea prior to use as a binder in many applications. Such urea-extended phenol/formaldehyde binders have been the mainstay of the fiberglass insulation industry for years, for example.

Over the past several decades however, minimization of volatile organic compound emissions (VOCs) both on the part of the industry desiring to provide a cleaner environment, as well as by Federal regulation, has led to extensive investigations into not only reducing emissions from the current formaldehyde-based binders, but also into candidate replacement binders. For example, subtle changes in the ratios of phenol to formaldehyde in the preparation of the basic phenol/formaldehyde resole resins, changes in catalysts, and addition of different and multiple formaldehyde scavengers, has resulted in considerable improvement in emissions from phenol/formaldehyde binders as compared with the binders previously used. However, with increasingly stringent Federal regulations, more and more attention has been paid to alternative binder systems which are free from formaldehyde.

One such candidate binder system employs polymers of acrylic acid as a first component, and a polyol such as glycerine or a modestly oxyalkylated glycerine as a curing or “crosslinking” component. The preparation and properties of such poly(acrylic acid)-based binders, including information relative to the VOC emissions, and a comparison of binder properties versus urea formaldehyde binders is presented in “Formaldehyde-Free Crosslinking Binders For Non-Wovens”, Charles T. Arkins et al., TAPPI JOURNAL, Vol. 78, No. 11, pages 161-168, November 1995. The binders disclosed by the Arkins article, appear to be B-stageable as well as being able to provide physical properties similar to those of urea/formaldehyde resins.

U.S. Pat. No. 5,340,868 discloses fiberglass insulation products cured with a combination of a polycarboxy polymer, a-hydroxyalkylamide, and an at least one trifunctional monomeric carboxylic acid such as citric acid. The specific polycarboxy polymers disclosed are poly(acrylic acid) polymers. See also, U.S. Pat. No. 5,143,582

U.S. Pat. No. 5,318,990 discloses a fibrous glass binder which comprises a polycarboxy polymer, a monomeric trihydric alcohol and a catalyst comprising an alkali metal salt of a phosphorous-containing organic acid.

Published European Patent Application EP 0 583 086 AI appears to provide details of polyacrylic acid binders whose cure is catalyzed by a phosphorus-containing catalyst system as discussed in the Arkins article previously cited. Higher molecular weight poly(acrylic acids) are stated to provide polymers exhibiting more complete cure. See also U.S. Pat. Nos. 5,661,213; 5,427,587; 6,136,916; and 6,221,973.

Some polycarboxy polymers have been found useful for making fiberglass insulation products. Problems of clumping or sticking of the glass fibers to the inside of the forming chambers during the processing, as well as providing a final product that exhibits the recovery and rigidity necessary to provide a commercially acceptable fiberglass insulation product, have been overcome. See, for example, U.S. Pat. No. 6,331,350. The thermosetting acrylic resins have been found to be more hydrophilic than the traditional phenolic binders, however. This hydrophilicity can result in fiberglass insulation that is more prone to absorb liquid water, thereby possibly compromising the integrity of the product. Also, the thermosetting acrylic resins now being used as binding agents for fiberglass have been found to not react as effectively with silane coupling agents of the type traditionally used by the industry. The addition of silicone as a hydrophobing agent results in problems when abatement devices are used that are based on incineration. Also, the presence of silicone in the manufacturing process can interfere with the adhesion of certain facing substrates to the finished fiberglass material. Overcoming these problems will help to better utilize formaldehyde-free polymers in fiberglass binders.

Accordingly, it is an objective of the present invention to provide a novel, non-phenol/formaldehyde binder.

Yet another object of the present invention is to provide such a binder which allows one to prepare fiberglass insulation products which are more water repellent and less prone to absorb liquid water.

Still another object of the present invention is to provide a fiberglass insulation product which exhibits good recovery and rigidity, is formaldehyde-free, and is more water-proof.

These and other objects of the present invention will become apparent to the skilled artisan upon a review of the following description and the claims appended hereto.

### SUMMARY OF THE INVENTION

In accordance with the foregoing objectives, there is provided by the present invention a novel fiberglass binder. The binder composition of the present invention comprises an epoxidized oil and a multifunctional carboxylic acid or anhydride.

A cross-linking reaction between the epoxidized oil and the multifunctional carboxylic acid or anhydride converts epoxy and carboxylic acid or anhydride functionalities to carboxylic esters and hydroxyl functionalities. The resulting binder is extremely water resistant. As a result, fiberglass insulation made with the binder of the present invention avoids the possible problem of coming apart when subjected to water, as the binder of the present invention has been found to repel the water and maintain the integrity of the bond with the fiberglass.

### DETAILED DESCRIPTION OF THE INVENTION

It has been surprisingly discovered that a binder comprising epoxidized oil and a multifunctional carboxylic acid or anhydride is extremely moisture resistant and rigid, and thus, is useful as a formaldehyde free binder for glass fibers.

Epoxidized oils suitable for use in the binder according to the present invention are prepared from natural oils. The main constituents of these natural oils are mixed triglycerides (esters of glycerol) having long-chain carboxylic acid moietes. These long-chain carboxylic acid moieties are twelve to eighteen carbon atoms in length. Preferably, the natural oils suitable for use in the present invention are obtained from vegetable sources. Accordingly, preferably, the natural oils are vegetable oils. As such, these oils are obtained from readily available and economical sources. Natural oils that may be suitable for use in the present invention include, for example, linseed oils, soybean oils, rapeseed oils, castor and dehydrated castor oils, coconut oils, palm and palm kernel oils, sunflower oils, tung oil, safflower oil, sunflower oil and the like, and mixtures thereof.

For use in the present invention, the natural oils are epoxidized. Accordingly, the epoxidized oils according to the present invention are epoxidized natural oils. Epoxidation creates cyclic 3-membered oxygen containing rings within the long-chains of the natural oils. These highly strained rings make the epoxidized oils reactive. To provide the epoxidized oils, natural oils may be epoxidized by methods well known to those of skill in the art. By way of example, the natural oils may be epoxidized using air oxidation, with enzyme-lipase, or with peracid, such as acetic acid or formic acid, in the presence of H₂O₂. In addition, the epoxidized oils suitable for use in the present invention are commercially available products.

The epoxidized oil suitable for use in the present invention can be a fully or partially epoxidized oil. By way of example, the epoxidized oil can be fully or partially epoxidized linseed oils, fully or partially epoxidized soybean oils, fully or partially epoxidized rapeseed oil, fully or partially epoxidized castor oil and dehydrated castor oil, fully or partially epoxidized coconut oils, fully or partially epoxidized palm and palm kernel oils, fully or partially epoxidized sunflower oils, and mixtures thereof.

The epoxidized oils suitable for use in the present invention may contain additional functionality. The alkyl chain of the epoxidized oils may be fully or partially saturated. As such, the epoxidized oils may contain some unsaturated functionality. The epoxidized oil may contain other reactive functional groups in addition to the epoxides, such as one or more double bonds in the alkyl chain, unsaturated acids, unsaturated esters, and the like, that can be utilized for further crosslinking reactions.

In the binder according to the present invention, the epoxidized oils may be applied as a mixture of different epoxidized oils or may be applied as a mixture of epoxidized oil and synthetic epoxies. Examples of synthetic epoxies that may be mixed with the epoxidized oil include bisphenol type epoxies, epoxidized poly butadiene, epoxy novolac, aliphatic and cyclo-aliphatic epoxies, and the like. The epoxidized oil suitable for use in the present invention can be prepared from a mixture of natural oil and synthetic epoxies by methods well known to those of skill in the art.

Preferably, the molecular weight of the epoxidized oil is 500-10,000, more preferably 500-2,000, and even more preferably about 500-1,000.

Since the epoxidized oils according to the present invention are multifunctional epoxies, they can be crosslinked with multifunctional carboxylic acids and anhydrides. The crosslinking reaction converts epoxy and carboxylic acid and anhydride functionalities to carboxylic esters and hydroxyl functionalities.

The multifunctional carboxylic acids and anhydrides suitable for use in the present invention are compounds containing a plurality of carboxylic acid or anhydride groups. The multifunctional carboxylic acids and anhydrides suitable for use in the present invention may be saturated or unsaturated and may be aromatic, aliphatic, or a combination of aromatic and aliphatic. In addition, the multifunctional carboxylic acids and anhydrides suitable for use in the present invention may comprise other functionalities such as one or more double bonds, esters, ethers, amines, amides, urethanes, ureas, melamines, carbonates, mixtures thereof, and the like. These additional functional groups can be utilized for further crosslinking reactions with the epoxidized oil.

The multifunctional carboxylic acids and anhydrides suitable for use in the present invention may be derived from the reaction of a linear or branched-chain multifunctional hydroxy-containing reactant (i.e., diols, polyols, hydroxyamines) with a linear, branched chain, cyclic, or aromatic carboxylic acid or anhydride, preferably a diacid or di-anhydride.

Preferred carboxylic acids or anhydrides for use in forming these multifunctional carboxylic acids and anhydrides of the present invention include, but are not limited to, maleic acid, maleic anhydride, phthalic acid or anhydride, isophthalic acid, tetraphthalic acid, pyromellitic anhydride or dianhydride, trimellitic acid or anhydride, oxalic acid, malonic acid, succinic acid or anhydride, adipic acid, sebasic acid or anhydride, fumaric acid, dimmer acids, poly acrylic acid, poly methacrylic acid, poly(styrene-co-maleic anhydride) and the like, and mixtures thereof.

Preferred multifunctional hydroxy-containing compounds for use in forming these multifunctional carboxylic acids and anhydrides include ethylene glycol, diethylene glycol, triethylene glycol, propylene glycol, dipropylene glycol, butanediol, tripropylene glycol, hexanediol, polyoxyethylene glycol, neopentyl glycol, trimethylpetanediol, pentaerythritol, dipentanerythritol, glycerin, methyl glucoside, sucrose, triethanol amine, and the like, and mixtures thereof.

The reaction to provide the multifunctional carboxylic acids and anhydrides is based on the reaction of one equivalent multifunctional hydroxy-containing compounds and two to three equivalents carboxylic acid or anhydride source. As such, the multifunctional acids and anhydrides may be prepared by methods well known to those of skill in the art.

Preferably, the molecular weight of the multifunctional acid or anhydride is 90-1,000,000, more preferably 90-100,000, and even more preferably about 90-50,000.

The binder according to the present invention is prepared by crosslinking the epoxidized oils with the multifunctional carboxylic acids or anhydrides by methods well known to those of skill in the art. The epoxidized oils are quite reactive. Accordingly, the crosslinking and curing reaction can occur slowly at ambient temperature and is accelerated at higher temperatures. A crosslinking catalyst or curing agent may be added to assist in the crosslinking and curing reaction. However, it is preferred that the reaction occur when heated rather than at ambient temperature so that the reaction can be properly controlled. The ratio of the number of equivalents of epoxidized oil to multifunctional carboxylic acid or anhydride in the binder is generally 1 to 1. The crosslinking reaction converts epoxy and carboxylic acid and anhydride functionalities to carboxylic esters and hydroxyl functionalities. In addition to epoxy and acid/anhydride functionalities, the components of the binder according to the present invention may contain other reactive functional groups such as one or more double bonds, unsaturated acids, unsaturated esters, and the like that can be utilized for further crosslinking reactions. Accordingly, the components of the binder have multiple sites at which crosslinking reactions occur. Preferably, the crosslinking and curing reaction creates a polymer of high molecular weight. The cured binder is extremely moisture resistant and rigid.

It is most preferred that the pH of the binder of the present invention be maintained in the range of from 3.0 to 9.0 to avoid serious problems with corrosion of the equipment and practical shelf life of the resin. while still realizing the benefits of the low pH. However, a lower pH can also be used, e.g., less than 3.0, and is actually preferred due to beneficial results, with appropriate handling precautions.

The binder according to the present invention may be applied to a surface neat. In the alternative, the binder according to the present invention may be applied to a surface in the form of an emulsion, suspension, or solution. Preferably, the binder is applied to a surface as an aqueous emulsion, which assists in controlling the viscosity of the binder. When applied as an aqueous emulsion, the binder is can be sprayed on the surface and the subsequent heating of the binder to cure will evaporate the water in which the binder was applied.

After application to the surface, preferably the components are heated to cure the binder. The binder composition of the present invention may also contain a cross-linking catalyst or curing agent. The cross-linking catalyst or curing agent may be silane coupling agents or imidazole. Preferably, the cross-linking catalyst is Imidazole or tertiary amines. The crosslinking catalyst may be added to the binder in an amount of from about 0.1 weight % to about 5.0 weight %, based on weight of the binder.

The binder composition according to the present invention may also contain conventional treatment components such as, for example, solvents, emulsifiers, pigments, filler, anti-migration aids, coalescents, wetting agents, biocides, plasticizers, organosilanes, anti-foaming agents, colorants, waxes, suspending agents, fillers, anti-oxidants, and mixtures thereof.

The binder composition may be prepared by admixing the epoxidized oil of the present invention and the multifunctional carboxylic acid or anhydride using conventional mixing techniques. In another embodiment, the acid intermediate and multifunctional hydroxy-containing reactant may be mixed and then the resulting multifunctional carboxylic acid or anhydride may then be mixed with the epoxidized oils. In yet another embodiment, the acid intermediate and multifunctional hydroxy-containing reactant may be mixed and the epoxidized natural oil may be mixed with a synthetic epoxy. Then the resulting multifunctional carboxylic acid or anhydride may then be mixed with the epoxidized oil and synthetic epoxy mixture. Other embodiments will be apparent to one skilled in the art.

After the binder composition of the present invention comprising epoxidized oil and multifunctional acid or anhydride has been prepared, other additives can then be mixed in with the composition to form the final composition. The final binder composition then can be applied to fiberglass. As molten streams of glass are drawn into fibers of random lengths and blown into a forming chamber where they are randomly deposited as a mat onto a traveling conveyor, the fibers, while in transit in the forming chamber, are sprayed with the binder composition of the present invention.

More particularly, in the preparation of fiberglass insulation products, the products can be prepared using conventional techniques. As is well known, a porous mat of fibrous glass can be produced by fiberizing molten glass and immediately forming a fibrous glass mat on a moving conveyor. The expanded mat is then conveyed to and through a curing oven wherein heated air is passed through the mat to cure the resin. The mat is slightly compressed to give the finished product a predetermined thickness and surface finish. Typically, the curing oven is operated at a temperature from about 150° C. to about 325° C. Preferably, the temperature ranges from about 180° to about 225° C. Generally, the mat resides within the oven for a period of time from about ½ minute to about 3 minutes. For the manufacture of conventional thermal or acoustical insulation products, the time ranges from about ¾ minute to about 1½ minutes. The fibrous glass having a cured, rigid binder matrix emerges from the oven in the form of a bat which may be compressed for packaging and shipping and which will thereafter substantially recover its vertical dimension when unconstrained.

The formaldehyde-free curable binder composition of the present invention may also be applied to an already formed nonwoven by conventional techniques such as, for example, air or airless spraying, padding, saturating, roll coating, curtain coating, beater deposition, coagulation, or the like.

The formaldehyde-free binder composition of the present invention, after it is applied to a nonwoven, is heated to effect drying and curing. If applied as an aqueous solution, the heating is sufficient to evaporate the water and remove any residual water from the binder composition. The duration and temperature of heating will affect the rate of drying, processability and handleability, and property development of the treated substrate. Heat treatment at about 120° C., to about 400° C., for a period of time between about 3 seconds to about 15 minutes may be carried out; treatment at about 150° C., to about 250° C., is preferred. The drying and curing functions may be effected in two or more distinct steps, if desired. For example, the composition may be first heated at a temperature and for a time sufficient to substantially dry but not to substantially cure the composition and then heated for a second time at a higher temperature and/or for a longer period of time to effect curing. Such a procedure, referred to as “B-staging”, may be used to provide binder-treated nonwoven, for example, in roll form, which may at a later stage be cured, with or without forming or molding into a particular configuration, concurrent with the curing process.

The heat-resistant nonwovens may be used for applications such as, for example, insulation batts or rolls, as reinforcing mat for roofing or flooring applications, as roving, as microglass-based substrate for printed circuit boards or battery separators, as filter stock, as tape stock, as tape board for office petitions, in duct liners or duct board, and as reinforcement scrim in cementitious and non-cementitious coatings for masonry. Most preferably, the products are useful as thermal or sound insulation. The nonwovens can also be used as filtration media for air and liquids.

The present invention will be further illustrated by the following examples, which are in no manner meant to be limiting in scope.

### EXAMPLES

### Example 1

### Preparation of Liquid Multifunctional Carboxylic Acids

A multifunctional carboxylic acid was prepared by the reaction of one equivalent ethylene glycol with two equivalents maleic anhydride to provide Multifunctional Carboxylic Acid A. In this regard, to 6.2 g ethylene glycol 19.6 g maleic anhydride was added and the mixture was heated to 60° C. After maleic anhydride was dissolved, 0.2 g triethyl amine was added to the mixture and the mixture was stirred at 60° C. for six hours.

A second multifunctional carboxylic acid was prepared by the reaction of one equivalent triethanol amine with two equivalents maleic anhydride to provide Multifunctional Carboxylic Acid B. In this regard, to 15 g triethanol amine 19.6 g maleic anhydride was added and the mixture was stirred at 60° C. for six hours.

A third multifunctional carboxylic acid was prepared by the reaction of one equivalent triethanol amine with three equivalents maleic anhydride to provide Multifunctional Carboxylic Acid C. In this regard, to 15 g triethanol amine 29.4 g maleic anhydride was added and the mixture was stirred at 90° C. for six hours.

### Example 2

### Preparation of Binder Composition

A binder composition was prepared by reaction of one equivalent epoxidized linseed oil with one equivalent Multifunctional Carboxylic Acid A. In this regard, to 12.9 g Acid A in a flask 17.4 g epoxidized linseed oil was added and the mixture was stirred at 60° C. until uniformity was obtained.

A second binder composition was prepared by reaction of one equivalent epoxidized linseed oil with one equivalent Multifunctional Carboxylic Acid B. In this regard, to 17.3 g Acid B in a flask 17.4 g epoxidized linseed oil was added and the mixture was stirred at 60° C. until uniformity was obtained.

### Example 3

### Use of the Binder Composition

To the binder compositions as prepared in Example 2 added 5% by weight benzoyl peroxide and were applied as thin films on the surface of glass slides and aluminum panels. The slides and panels were cured in an oven at 200° C. for 20 minutes. The resulting cured films were hard and insoluble in water and in methyl ethyl ketone.

The binder composition (12.5 g), as prepared in Example 2 by reaction of one equivalent epoxidized linseed oil with one equivalent Multifunctional Carboxylic Acid A containing 5% by weight benzoyl peroxide, was added to 250 g glass beads. The combination was mixed for 10 minutes and used to form glass bead/binder composites. The composites were cured in oven at 200° C. for 20 minutes. The tensile strength of the composites and moisture resistance were measured by measuring water pickup by weight. The tensile strength and moisture resistance were comparable with commercial fiberglass sizing resins.

### Example 4

### Preparation and Use of the Binder Emulsion

To 87 g water 4.0 g sodium hydroxide was added and dissolved. To this solution 20 g poly styrene maleic anhydride (SMA) was added and the mixture was stirred and heated to 90° C. until SMA was dissolved. The solution was cooled to 60° C. and while under high agitation, 8.7 g epoxidized linseed oil was added and emulsified. The emulsion was tested by dynamic mechanical measurement by increasing the temperature at 20 C/minute to 200 C and held for 10 minutes. The cured binder had a storage modulus of 176 MPa, comparable with that of commercial polyacrylic acid based resins.

### Example 5

### Preparation and Use of the SMA Binder Solution

To 87 g MEK 20 g poly styrene maleic anhydride (SMA) was added and the mixture was stirred until SMA was dissolved. To this solution 17.4 g epoxidized linseed oil and 0.5 g triethyl amine were added and dissolved. The modulus of the cured binder tested by the method described in Example 4 had a storage modulus of 111 MPa.

While the invention has been described with preferred embodiments, it is to be understood that variations and modifications may be resorted to as will be apparent to those skilled in the art. Such variations and modifications are to be considered within the purview and the scope of the claims appended hereto.

What is claimed is:

1. A fiberglass binder comprising epoxidized oil and a multifunctional carboxylic acid or anhydride.

2. The fiberglass binder of claim 1, wherein the epoxidized oil is selected from the group consisting of fully or partially epoxidized linseed oils, fully or partially epoxidized soybean oils, fully or partially epoxidized rapeseed oil, fully or partially epoxidized castor oil and dehydrated castor oil, fully or partially epoxidized coconut oils, fully or partially epoxidized palm and palm kernel oils, fully or partially epoxidized sunflower oils, fully or partially epoxidized tung oil, fully or partially epoxidized safflower oil, fully or partially epoxidized sunflower oil and mixtures thereof.

3. The fiberglass binder of claim 1, wherein the fiberglass binder comprises a mixture of epoxidized oil and synthetic epoxies.

4. The fiberglass binder of claim 3, wherein the synthetic epoxies are selected from the group consisting of bisphenol type epoxies, epoxidized poly butadiene, epoxy novolac, aliphatic epoxies, cyclo-aliphatic epoxies, epoxy acrylates and mixtures thereof.

5. The fiberglass binder of claim 1, wherein the fiberglass binder further comprises a component selected from the group consisting of solvents, emulsifiers, pigments, filler, anti-migration aids, coalescents, wetting agents, biocides, plasticizers, organosilanes, anti-foaming agents, colorants, waxes, suspending agents, fillers, anti-oxidants, crosslinking catalyst, and mixtures thereof.

6. The fiberglass binder of claim 1, wherein the multifunctional carboxylic acid is derived from the reaction of a linear or branched-chain multifunctional hydroxy-containing reactant with a linear, branched chain, cyclic, or aromatic carboxylic acid or anhydride.

7. The fiberglass binder of claim 6, wherein the linear or branched-chain multifunctional hydroxy-containing reactant is selected from the group consisting of ethylene glycol, diethylene glycol, triethylene glycol, propylene glycol, dipropylene glycol, butanediol, tripropylene glycol, hexanediol, polyoxyethylene glycol, neopentyl glycol, trimethylpetanediol, pentaerythritol, dipentanerythritol, glycerin, methyl glucoside, sucrose, triethanol amine, and mixtures thereof.

8. The fiberglass binder of claim 6, wherein the linear, branched chain, cyclic, or aromatic carboxylic acid or anhydride is selected from the group consisting of maleic acid, maleic anhydride, phthalic acid or anhydride, isophthalic acid, tetraphthalic acid, pyromellitic anhydride or dianhydride, trimellitic acid or anhydride, oxalic acid, malonic acid, succinic acid or anhydride, adipic acid, sebasic acid or anhydride, fumaric acid, dimmer acids, and mixtures thereof.

9. The fiberglass binder of claim 1, wherein the multifunctional carboxylic acid or anhydride contains other functionalities selected from the group consisting of ester, ether, amine, urethane, urea, melamine, carbonate, and combinations thereof.

10. The fiberglass binder of claim 1, wherein the multifunctional carboxylic acid or anhydride is homo or copolymers of acrylic acid, homo or copolymers of methacrylic acid, homo or copolymers of crotonic acid, homo or copolymers of maleic anhydride, homo or copolymers of maleic acid, and mixtures thereof.

11. The fiberglass binder of claim 1, wherein the molecular weight of the epoxidized oil is 250-2000.

12. The fiberglass binder of claim 1, wherein the molecular weight of the multifunctional carboxylic acid or anhydride is 90-50,000.

13. The fiberglass binder of claim 1, wherein the binder further comprises a crosslinking catalyst.

14. The fiberglass binder of claim 13, wherein the crosslinking catalyst is Imidazole or tertiary amines.

15. The fiberglass binder of claim 1, wherein the binder comprises an amount of epoxidized oil to an amount of multifunctional carboxylic acid or anhydride in a ratio of 1:1.

16. The fiberglass binder of claim 1, wherein the binder is applied neat.

17. The fiberglass binder of claim 1, wherein the binder is applied as an emulsion, suspension, or solution.

18. A fiberglass binder comprising an aqueous solution of epoxidized oil and a multifunctional carboxylic acid or anhydride.

19. A fiberglass product comprising a mat of glass fibers containing the binder of claim 1.

20. A fiberglass product comprising a mat of glass fibers containing the binder of claim 18.

21. The fiberglass product of claim 19, wherein the product is building insulation.

22. The fiberglass product of claim 19, wherein the product is reinforcing mat for roofing or flooring.

23. The fiberglass product of claim 19, wherein the product is a microglass-based substrate useful for printed circuit boards or battery separators, filter stock, tape stock or reinforcement scrim.

24. The fiberglass product of claim 19, wherein the product is filter stock.

25. A fiberglass product prepared by using a binder comprised of epoxidized oil and a multifunctional carboxylic acid or anhydride.

26. The fiberglass product of claim 25, wherein the product is thermal or sound insulation, or filtration media for air or liquids.
